(19) United States
(12) Patent Application Publication
(10) Pub. No.: US 2013/0107044 A1
(43) Pub. Date: May 2, 2013

(54) Blind Spot Camera System

(71) Applicant: Anthony Azevedo, Canton, TX (US)

(72) Inventor: Anthony Azevedo, Canton, TX (US)

(21) Appl. No.: 13/281,523

(22) Filed: Oct. 26, 2011

(51) Int. Cl. H04N 7/18

(52) U.S. Cl. 348/148; 348/E07.085

(57) ABSTRACT

A camera system to provide a view of otherwise blind spots on a tractor trailer vehicle comprising: at least one video screen, where said one video screen is positioned on the driver's visor; and at least one pair of cameras, where at least one camera is positioned on each side of a oversize load trailer and the cameras transmit wireless video signals for depiction on the at least one video screen. In one particular embodiment, each camera according to the present invention is attached to the forward corners of the oversized load. Further a third camera may be attached the rear portion of the tractor at the top of the cab.

### BACKGROUND OF THE INVENTION

1. Field of Invention

The present invention relates to a camera and video system for providing a view of blind spots surrounding a wide-load tractor-trailer.

2. Description of Related Art

Tractor-trailers are used to transport goods and cargo across the country on the highways and roads. The tractor-trailer combinations include a tractor and a single trailer that may be hitched and unhitched from the tractor. These cargo vehicles are substantially larger than most vehicles on the highway and require unique skills and training to handle. Due to the size of the vehicles, it is particularly important to be aware of other vehicles on the road in order to avoid accidents. Rearview mirrors are provided for tractor-trailers on each side with special mirrors to minimize the blind spot that is inevitable on every vehicle. Although mirror systems help to minimize the area that is not visible, the blind spot, the mirrors still leave an area on each side of the vehicle that the driver is unable to see while operating the tractor.

Some systems have been developed to provide a visual of these blind spots by installing cameras in particular locations on the tractor or on the bumper of the trailer so that the driver may have a visual of these areas. Wide load or oversize load tractor-trailer vehicles create special or additional problems with respect to blind spots. Many times the oversize or wide-load cargo has additional length and width, which creates larger blind spots due to the size of the load on the trailer. These special wide loads need additional means to locate or to provide a visual of the blind spot created by the trailer. It would therefore be advantageous to have a system in place that is particularly designed for wide load trailers that assist the driver in having a full visual of the area surrounding the wide load.

### SUMMARY OF THE INVENTION

The present invention relates to a camera system to provide a view of otherwise blind spots on a tractor trailer vehicle comprising: at least one video screen, where said one video screen is positioned on the driver's visor; and at least one pair of cameras, where at least one camera is positioned on each side of a oversize load trailer and the cameras transmit wireless video signals for depiction on the at least one video screen. In one particular embodiment, each camera according to the present invention is attached to the forward corners of the oversized load. Further a third camera may be attached the rear portion of the tractor at the top of the cab. The cameras according to the present invention transmit wireless signals that are picked up by the at least one video screen and the cameras may pivot up to 180 degrees.

### BRIEF DESCRIPTION OF DRAWINGS

FIG. 1 depicts visor video screens according to the present invention.

FIG. 2 depicts a camera system according to the present invention.

FIG. 3 depicts a camera lens used in the camera system according to the present invention.

### DETAILED DESCRIPTION

The present invention provides a camera system that is installed on a wide-load trailer to provide the driver with a visual of otherwise blind spots on each side of the wide load. The camera system according to the present invention places two wireless video cameras on each corner of an oversized load and provides video screens on the visor of the cab area that depicts images captured by the cameras. The camera system according to present invention therefore helps the driver to have a better view of the sides of the wide load and helps to eliminate blind spots that may occur if otherwise not used. By using the camera system, the driver may transport oversized or even normal size loads more safely and reduce the risks of accident while driving. The increased vision that may be achieved using the present helps the driver to maneuver the load around tight spots.

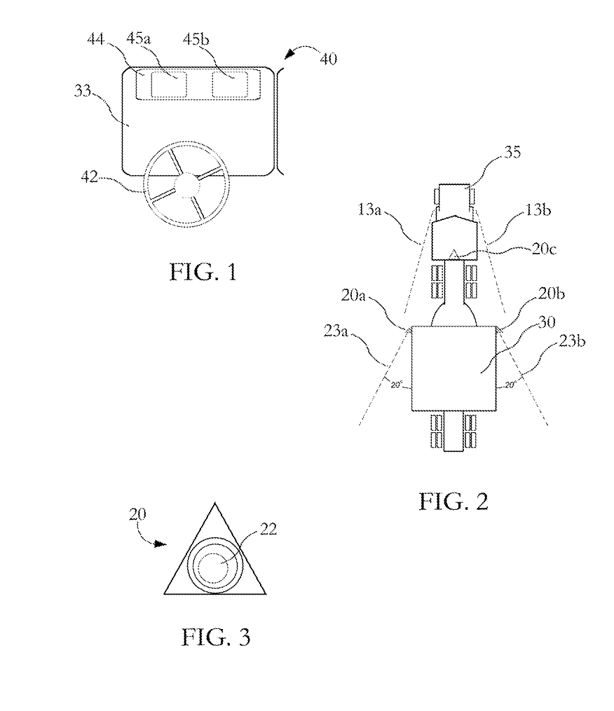

FIG. 1 depicts a cab area 40 of a tractor which includes video screens in accordance with the present invention. The cab area 40 includes a windshield 33 with a visor 44. Two LCD video screens 45a, 45b are positioned on the visor 44. The LCD video screens 45a, 45b provide images that are picked up by cameras placed on the outside corners of the load being pulled by the tractor. The visor 44 is positioned on the driver's side and therefore a steering wheel 42 is also provided on the driver's side of the cab. The visor 44 and screens 45a, 45b may be positioned to allow the driver to maintain a view of the roadway and glimpse at the visuals provided by the screens 45a, 45b. The images shown on the video screens 45a, 45b are picked up by the cameras as depicted in FIG. 2.

FIG. 2 provides an overview of the camera system in accordance with the present invention. A tractor 35 is shown with an attached wide load 30 in FIG. 2. The oversized or wide load 30 may be up to 18 feet in width. Due to the width of the oversized load 30, the normal rear view provided by the tractor is limited. The normal rear view provided by the mirrors is depicted at views 13a, 13b as shown, therefore the driver simply cannot see around the oversize load 30 via the mirrors provided on the tractor 35. Cameras 20a, 20b are attached to the forward corners of the oversized load 30. These cameras 20a, 20b enable for the driver to have a more significant view of the surrounding areas near the oversized load 30. View angles 23a, 23b are depicted on each side of the oversized load 30 and are obtainable due to the cameras 20a, 20b. A third camera 20c may be attached the rear portion of the tractor 35. The camera 20c may be position at the top of the cab at rear of the tractor 35. The camera 20c provides the driver with a view of the top of the load 30 and therefore insures that the load fits under in any over pass that may be encountered.

The cameras 20a, 20b, 20c transmit wireless signals that may be picked up by the video screens 45a, 45b. Each video screen 45a, 45b is associated with a particular camera within the camera system. In one particular embodiment, the video screen 45a depicts the view provided by camera 20a and video screen 45b depicts the view depicted via camera 20b. The video screens 45a, 45b enable the driver to view along each side of the oversized load 30 and eliminate the blind spot associated with traveling with the oversize load 30. Each camera 20a, 20b may be designed to pivot up to 180 degrees after being mounted and positioned at each forward corner of the load 30. The view of camera 20c may also be adjusted as needed.

FIG. 3 depicts a camera lens in accordance with the present invention. The camera 20 is shown with a lens 22. In this particular embodiment, the camera 20 includes a triangular housing where the lens 22 is able to rotate up to 180 degrees during operation. The use of the camera 20 on each side of the wide load therefore improves the visibility for the driver and helps to detect other vehicles or objects that may be in or near the load 30. The camera system according to the present invention may include control mechanisms not depicted. The control mechanisms may be able to effectively rotate or zoom the cameras as needed to pinpoint particular objects or viewpoints as desired by the user. The cameras 20a, 20b, 20c may be within a housing to protect against shock, weather changes and temperature variations. The system according to present invention may be very suitable for any oversize load carrier and in particular for mobile home and house movers or transporters. The instant invention has been shown and described in what it considers to be the most practical and preferred embodiments. It is recognized, however, that departures may be made there from within the scope of the invention and that obvious modifications will occur to a person skilled in the art.

What is claimed is:

1. A camera system to provide a view of otherwise blind spots on a tractor trailer vehicle comprising:
a. at least one video screen, where said one video screen is positioned on the driver's visor; and
b. at least one pair of cameras, where at least one camera is positioned on each side of a oversize load trailer and the cameras transmit wireless video signals for depiction on the at least one video screen.

2. The camera system according to claim 1, where each camera is attached to the forward corners of the oversized load.

3. The camera system according to claim 1, where a third camera is attached the rear portion of the tractor at the top of the cab.

4. The camera system according to claim 3, where cameras transmit wireless signals that are picked up by the at least one video screen.

5. The camera system according to claim 3, where the cameras pivot up to 180 degrees.
